(19) United States
(12) Patent Application Publication
(10) Pub. No.: US 2008/0231883 A1
(43) Pub. Date: Sep. 25, 2008

(54) USAGE BASED SERVICE SOLUTION

(76) Inventor: Trevor James Snyder, Newberg, OR (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/689,114

(22) Filed: Mar. 21, 2007

(51) Int. Cl. G06F 3/12

(52) U.S. Cl. 358/1.15

(57) ABSTRACT

A method of monitoring at least one printing device via a communication network is disclosed. An error identifier and a usability identifier are received from the printing device. The printing device is commanded to display a fault code. A service occurs as a response to the error identifier and the usability identifier. The level of service is dependent on the error identifier and the usability identifier.

### BACKGROUND

Various methods of tracking device usage are known in the art. In one example, U.S. Patent Application Publication Number 2006/0190324, the disclosure of which is incorporated herein by reference, discusses reducing a customer's imaging cost by determining a rate of an imaging substance. In another example, U.S. Patent Application Publication Number 2006/0120735, the disclosure of which is incorporated herein by reference, discusses tracking a customer's usage of an imaging substance and giving the customer an offer related to the unused imaging substance. In U.S. Patent Application Publication No. 2004/0138945, the disclosure of which is incorporated herein by reference, a rate of supply item consumption is determined for a customer and a reward is given as a result of the usage.

The methods of the prior art merely provide a consumer with a reward or service rate based solely on the consumption over a particular period of time. Furthermore, the methods taught are limited to tracking consumption on a single device.

Therefore, the disclosure contained herein describes methods of resolving one or more of the problems discussed above.

### SUMMARY

In an embodiment, a method of servicing a printing device includes monitoring at least one printing device via a communication network, receiving an error identifier and a usability identifier, commanding the printing device to display a fault code, and responding to the error identifier and the usability identifier with a service. The service has a level that is dependent on the error identifier and the usability identifier.

The usability identifier may represent usage of the printing device or multiple devices in the communication network over a period of time. The commanding may include, for example, displaying the fault code in a display area of the printing device and or printing the fault code. The fault code may be dependent upon the usability identifier and the error identifier. In an embodiment, the error identifier represents a maintenance issue in the printing device.

Optionally, the service may include items such as: (i) automatically talking action to resolve the maintenance issue, without requiring input from a user of the device; (ii) displaying priority service center contact information based on the fault code; (iii) offering a user the opportunity to communicate, via an input apparatus in the at least one printing device, with a service center; (iv) sending a command to print, by the at least one printing device, an offer for a reward based on the fault code; (v) displaying a reward based on the fault code; (vi) sending a command to print, by the printing device, usage information of at least one printing device in the communication network; and/or (vii) displaying a service instruction. Optionally, the responding may include commanding the printing device to display contact information for a service center, wherein the contact information is dependent on the service level. The commanding may be initiated by the printing device.

In an alternate embodiment, a method includes monitoring at least one printing device via a communication network, receiving an error identifier and a usability identifier, commanding the printing device to display a fault code that is dependent upon the usability identifier and the error identifier, identifying a service level that is dependent on the usability identifier, and automatically responding to the error identifier and the usability identifier by displaying a service instruction that is dependent upon the service level. Optionally, the service instruction may include a reward based on the usability identifier and/or displaying a priority service number if the usability identifier exceeds a certain value. Displaying a service instruction may include, in some embodiments, displaying contact information for a service center, wherein the contact information is dependent on the service level.

In an alternate embodiment, a system includes a printing device configured to pass an error identifier and a usability identifier to a server via a communication network. The server responds to the error identifier and the usability identifier by determining a service for the printing device. The service has a level that is dependent on the error identifier and the usability identifier.

### BRIEF DESCRIPTION OF THE DRAWINGS

FIG. 1 is a block diagram that depicts exemplary elements of a printing device that is networked with multiple computing devices.

FIG. 2 depicts one embodiment of a flowchart of a usage based service solution.

### DETAILED DESCRIPTION

Before the present methods systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition the word “comprising” as used herein is intended to mean “including but not limited to.” Unless defined otherwise, all technical and scientific terms used herein have the same meanings as commonly understood by one of ordinary skill in the art.

This disclosure is generally directed to monitoring a device in a communication network to determine servicing needs. In particular, the device may be given different types of service based on its usage. An embodiment of the disclosure may be directed to a method of providing service based on the usage of a printing device. At least one printing device which is in communication with a network may be monitored. A command may be sent to display a fault code in a display area of the printing device. The fault code may comprise an error identifier, a usability identifier, or a combination of both. The system may then respond to the fault code.

A printing device is an electronic device that is capable of receiving commands and printing text and/or images on a substrate. Printing devices may include but are not limited to, printers, copiers, faxes, scanners or other devices using ink or toner. As used herein, the words “ink” and “toner” are used interchangeably to refer to wet or dry material that forms an image or text on a substrate. Printing devices may also contain a combination of functions.

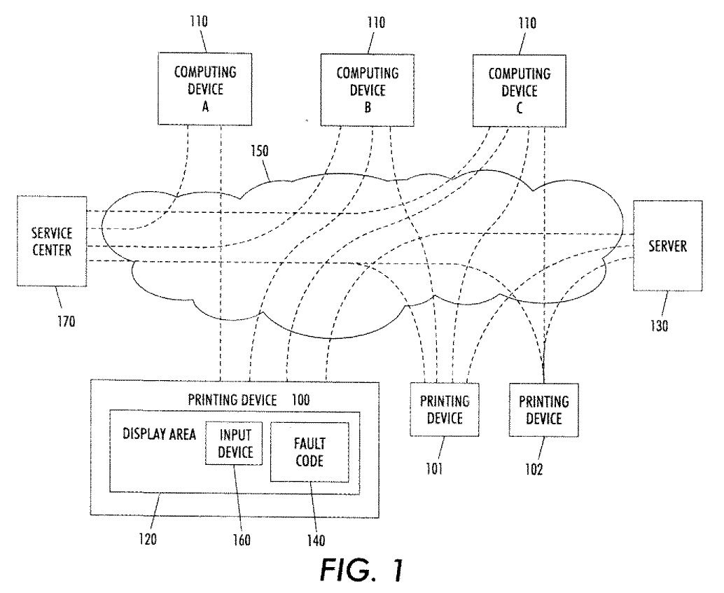

In one embodiment, as shown in FIG. 1, one or more printing devices 100 are in communication with one or more computing devices 110 via a network 150 such as a local area network (LAN), wide area network (WAN), Internet or another communications network. The computing devices 110 may, in some embodiments, be connected to the printing device 100 via multiple communications networks 150. In another embodiment, one or more of the computing devices may be connected to multiple printing devices 100, 101, 102 via one or more networks. Alternatively, the computing devices 110 may be connected to a single printing device 100. Computing devices 110 may include, but are not limited to, computers, cell phones, personal digital assistants, gaming systems, and/or other electronic devices capable of communicating in a networked environment. As used herein, the words “connected” and “connection” refers to devices that are configured on one or more networks so that they can pass information to each other through the network.

In one embodiment, a printing device 100 may contain a display area 120. A display area 120 is an electronic changeable device that represents information in visual form. A display area 120 may include, but is not limited to, a liquid crystal display (LCD), plasma display, digital light processing (DLP) display, or a light-emitting diode (LED) display. The display area 120 of a printing device 100 may receive commands to display a fault code 140. A fault code 140 may include an error identifier, a usability identifier, or a combination of both.

An error identifier may track failures, warnings, and/or maintenance issues which may occur in a printing device 100. For example, a paper jam error, three year maintenance check, low toner warning, out of ink error, and/or any of a number of possible broken printer parts such as the printhead, process motors, and thermal systems, may be represented with different error identifiers. In one embodiment, the error identifier may be determined internally using electronic memory inside the printing device. In another embodiment, the error identifier may be determined externally via a server 130 in communication with the network 150. The error identifier may be a numeric number, letter, symbol, a combination of these items, or another displayable image.

The usability identifier may be an indicator of the usage of a printing device 100. The usability identifier may be determined by an algorithm using usage information which may include, but is not limited to, the volume of pages printed and/or the ink and/or toner coverage of each page printed. The usability identifier may be determined based on a single printing device 100 or it may be determined based on a group of networked printing devices 100, 101, 102. In one embodiment, the usability identifier tracks the use within an individual printing device 100. In another embodiment, the usability identifier is determined externally via a server 130 in communication with the network 150. In one embodiment, the server 130 may individually track the usability identifier for each printing device 100, 101, 102 in the network 150. In another embodiment, the server 130 may aggregate the usage of the printing devices 100, 101, 102 in the network 150 to determine a single usability identifier. For example, a company may have computing devices 110 that are in communication with one or more printing devices 100, 101, 102 and the use of each printing device 100, 101, 102 may be aggregated to determine a single usability identifier. This aggregation may allow the usability identifier to reflect the company's overall use and not the use of one particular printing device 100. If the company has printing devices 100, 101, 102 which aggregate use in determining the usability identifier, each printing device 100, 101, 102 may contain or display information, like a fault code using the aggregated usability identifier.

In one embodiment, the usability identifier may consist of three parts. In one embodiment, each part of the usability identifier can be a scaled value of the ink coverage multiplied by the print volume over a set interval. One part may be the current usage, such as usage over the past week or the usage over the past month. The second part may be the usage over a past period of time such as, but not limited to, the usage over the past two or three months. The third part may be the usage over a more extended period of time such as, but not limited to, usage over the past six months or usage the past year or even since the printers start of life, etc. In one embodiment, these parts may be displayed in any order. In one embodiment, there may be more or less than three parts that comprise the usability identifier. In one embodiment, the usability identifier can be compared to target levels.

In another embodiment, the usability identifier may include any number of parts or sections. For example, one part may represent the usage of a printing device over the length of time the printing device was owned. One part may represent the usage of printing device since the printing device last obtained a reward. In other embodiments, the usage of the printing device may be determined over various lengths of time, such as, but not limited to, a random length of time, a set time period, or an event or occurrence.

The fault code may be a combination of both the error identifier and the usability identifier. The error identifier and usability identifier may each be displayed as part of the fault code as part as a symbol, number, letter, image, bar graph or a pie chart. The usability identifier may be a percentage displayed by an image, graph, chart or a number between 0 and 100. Alternatively, the fault code may be an alphanumeric code that is based on both the error identifier and the usability identifier.

The usability identifier and the error identifier can be combined to create various fault codes with a single display in the display area. In another embodiment, the fault code may be printed by the printing device. In one embodiment, an error identifier may identify that there is a problem inside a printing device. A printing device with a high usability identifier may display a different fault code than a printing device with a low usability identifier even though both printing devices contain the same error identifier. In one embodiment where the fault code varies with usability identifier, the usability identifier may be categorized in ranges.

For example, if the error identifier is A and the usability identifier is less than or equal to 50% of a predetermined target, the fault code may be X. If the error identifier is A and the usability identifier is greater than 59% of target and is equal to or lower than 75% of target, the fault code may be Y. Lastly, if the error identifier is A and the usability identifier is greater than 75% of target, then the fault code may be Z. Alternatively, instead of usability identifier ranges, the usability identifier may have to exceed a single threshold or exceed multiple thresholds in order for different fault codes to be displayed.

The system may respond to a fault code if the printing device is active. Optionally, a printing device may be active when it can display the fault code, communicate with a customer, and/or communicate with a servicing center. The fault code may be used to determine the level or type of service received by a customer of a printing device.

In one embodiment, the system can respond to a fault code by displaying a phone number, e-mail address, or other contact instructions for a service center. There may be multiple numbers for a service center. There may be one number that is given to printing devices with one fault code and a different service number that is given to printing devices with a different fault code. In another embodiment, the fault code may be hidden from the user and only available to an authorized person, such as a service technician. Alternatively, the fault code may include instructions that the user communicates to a service technician so that the service technician can diagnose the fault.

In one embodiment, the user prompt (which may include a fault code, contact instructions or both) may be located in the display area of the printing device. Referring to FIG. 1, the printing device's display area 120 may contain another screen or screen section which provides information, such as, but not limited to, the contact instructions. A customer of a printing device may use the contact instructions (for example, call the displayed service number) to receive assistance. In another embodiment, the prompt may be displayed on the server 130 or the user's computing device 110, triggered from a print driver on the server or user computing device.

In another embodiment, the printing device may connect to the service center via an input device. The input device 160, as depicted in FIG. 1, is a structural element of the printing device 100 that allows a customer to enter a command into the device. The input device 160 may include, but is not limited to, a button, lever, keyboard, or touch screen. If the printing device 100 contains an input device 160, the printing device may be communication with the service center through the use of a telephone line, WAN, LAN, Internet or other communication channel. The input device 160 may be used by a customer of the printing device 100 to contact the service center 170. In one embodiment, the printing device 100 may connect through a communication device to the service center 170. In one embodiment, the customer may then enter information into the printing device 100 to relay to the service center 170. In another embodiment, the printing device 100 may automatically send the fault code, error identifier, and/or usability identifier, to the service center 170 after the input device 160 is used by a customer. The printing device 100 may also send the service center 170 other pertinent information such as, but not limited to, the location of the printing device 100 and a person to contact regarding the printing device 100.

The input device may be enabled only for certain fault codes. In one embodiment, the input device may be used to initiate communication with different service centers based on the fault code. The input device may connect to different service centers based on the usability identifier and/or the error identifier in the fault code. In another embodiment, the input device may be used to initiate communication with other entities such as, but not limited to, printing device suppliers, maintenance centers, help centers, and oilier entities associated with a printing device.

Instead of waiting for a customer to use the input device, the printing device may respond to a fault code by automatically connecting to a service center. In one embodiment, the printing device may automatically connect to a service center only if the printing device contains a specific fault code. In another embodiment, the fault code must be at least a certain value for the printing device to automatically connect to the service center. The printing device may automatically transmit information to the service center including its fault code. In one embodiment, the service center may schedule maintenance on the printing device based on its fault code. In another embodiment, the service center may send out a repair person based on the fault code. Alternatively, the service center may not respond to the fault code.

In one embodiment, a printing device may respond to a fault code by displaying usage information. Usage information is data regarding current and previous operation of a printing device. In one embodiment, the usage information may contain data on the consumption of materials such as ink or toner. In another embodiment, the usage information may contain data on maintenance requirements and/or the status of other components inside the printing device. In one embodiment, the usage information may be selected based only on the usability identifier. Alternatively, the usage information may be selected based on the error identifier and the usability identifier.

The usage information may be printed by the printing device or it may be displayed to a customer of the printing device. In one embodiment, a printer driver on the customer's computer may select the path for delivery of the usage information. The usage information may be displayed or printed at a set period of time, a random period of time, or some combination thereof. The usage information may be displayed based on the usability identifier in the fault code and/or the time period. In one embodiment, the usage information may be displayed only if there is a high usability identifier in the fault code over a set period of time.

In another embodiment, a printing device may respond by offering a reward based on the printing device's fault code or usability identifier. The type of reward may be determined based on the usability identifier in the fault code. In one embodiment, rewards may be determined by the fault code containing a certain usability identifier within a set period of time. In another embodiment, rewards may be determined when the fault code contains a usability identifier for a certain period of time.

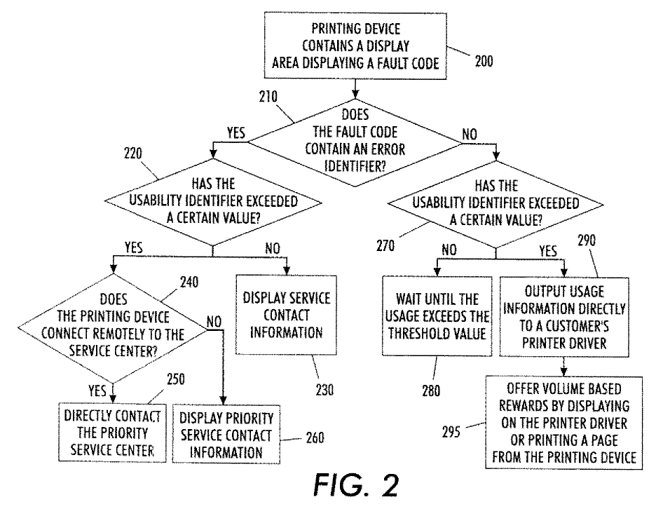

FIG. 2 describes one possible embodiment of a usage based service solution. First, a printing device may display a fault code 200. Different services may be provided depending on if the fault code contains an error identifier 210. The system may determine if the usability identifier contained within the fault code exceeds a threshold value, or is within a threshold range, or matches a predetermined identifier 220. A single threshold value may be used to assess the fault code and differentiate various printing devices. The threshold value may be, but is not limited to, a certain amount, percentage, average or weighted average.

If the usability identifier contains a set of numbers, the system may take all the values into account when determining if a threshold value has been exceeded. In one embodiment, a weighted threshold value may allow a printing device that was frequently used in the past year or past month, but has been infrequently used currently, to still contain a fault code that exceeds the threshold value. Alternatively, only a certain time period may be examined. For example, the threshold value may only look at a usability identifier that includes usage for the past 6 months.

For example, the fault code can contain a usability identifier with percentages which indicate the weekly usage, past 3 months' usage, and yearly usage as compared to other printing devices. The usability identifier can be 30, 90, and 98. These numbers may show that previously, the printing device was highly used, but it had low usage during the past week due to errors in the printing device. Therefore, the system may determine that due to past performance, the printing device exceeds a certain usage even though in the past week the usage was low.

In another embodiment, the system may take the usability value in account to determine usage of a printing device from a specific point in time. For example, the usability value could contain all the usage of the printing device since new toner was installed. Alternatively, the usability value could be based on the age of the printing device or the time period that the customer owned the printing device.

If the system determines that the fault code does not exceed the threshold value 220, then the device may provide alternate levels of service or rewards. For example, a telephone number can be displayed for a service center 230. The service number displayed may be a number given to devices that do not exceed the threshold value. Once a customer dials the service number, they may be asked to give a service representative the fault code displayed on their printing device.

If the usability identifier exceeds the threshold value, then the system may determine if the printing device can be remotely contacted 240. If remote contact is available, the servicing center may be contacted directly from the machine 250 to automatically provide the service center with the fault code and initiate service. Alternatively, or in addition, in one embodiment, the display area may contain different contact information such as a phone number only given to devices which include a usability identifier exceeding the threshold value. Optionally, a customer may initiate contact with this service center through the input device on the printing device. In addition, or if there is no input device, the printing device may display this service contact information 260 on the display screen. Alternatively, if the printing device does not contain an input device, the phone number may be printed from the printing device. A customer can inform the service center of the fault code and other necessary information including but not limited to, location, contact information, contact phone number, and other information useful for servicing a printing device.

Alternatively, the usage based service solution may refer to services not related to errors and contacting the service center. In one embodiment, the fault code is based only on whether the usability identifier has exceeded the threshold value 270. The printing device may examine the usability identifier of the fault code at a set period of time, at a random period of time, or some combination thereof. If usability identifier does not exceed the threshold value, the system may examine the device at the next random or preset time 280. Alternatively, the usability identifier of the fault code may exceed the threshold value. If the fault code is exceeded, then the customer may output information about the usage of the printing device directly to a customer's printer driver 290. Additionally, or in the alternative, rewards may be offered to one or more customers based on the usability identifier 295.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
monitoring at least one printing device via a communication network;
receiving an error identifier and a usability identifier;
commanding the at least one printing device to display a fault code; and
responding to the error identifier and the usability identifier with a service, wherein the service has a level that is dependent on the error identifier and the usability identifier.

2. The method of claim 1, wherein the usability identifier represents usage of the at least one printing device in the communication network over a period of time.

3. The method of claim 1, wherein the commanding comprises displaying the fault code in a display area of the at least one printing device.

4. The method of claim 1, wherein the commanding comprises printing, by the at least one printing device, the fault code.

5. The method of claim 1, wherein the fault code is dependent upon the usability identifier and the error identifier.

6. The method of claim 1, wherein the error identifier represents a maintenance issue in the at least one printing device.

7. The method of claim 6, wherein the service comprises automatically taking action to resolve the maintenance issue, wherein the action is initiated without the requirement for input from a user of the device.

8. The method of claim 6, wherein the service comprises displaying priority service center contact information based on the fault code.

9. The method of claim 1, wherein the responding comprises commanding the printing device to display contact information for a service center, wherein the contact information is dependent on the service level.

10. The method of claim 1, wherein the service comprises offering a user the opportunity to communicate, via an input apparatus in the at least one printing device, with a service center.

11. The method of claim 1, wherein the commanding is initiated by the at least one printing device.

12. The method of claim 1, wherein the service comprises sending a command to print, by the at least one printing device, an offer for a reward based on the fault code.

13. The method of claim 1, wherein the service comprises displaying a reward based on the fault code.

14. The method of claim 1, wherein the service comprises sending a command to print, by the at least one printing device, usage information of at least one printing device in the communication network.

15. The method of claim 1, wherein the service comprises displaying a service instruction.

16. A method comprising:
monitoring at least one printing device via a communication network;
receiving an error identifier and a usability identifier;
commanding the at least one printing device to display a fault code that is dependent upon the usability identifier and the error identifier;
identifying a service level that is dependent on the usability identifier; and
automatically responding to the error identifier and the usability identifier by displaying a service instruction that is dependent upon the service level.

17. The method of claim 16, wherein the service instruction is a reward based on the usability identifier.

18. The method of claim 16, wherein the service instruction comprises displaying a priority service number if the usability identifier exceeds a certain value.

19. The method of claim 16, wherein the displaying a service instruction comprises:
displaying contact information for a service center, wherein the contact information is dependent on the service level.

20. A system comprising:
a printing device configured to pass an error identifier and a usability identifier to a server via a communication network;
wherein the server responds to the error identifier and the usability identifier by determining a service for the printing device, wherein the service has a level that is dependent on the error identifier and the usability identifier.
